(19) United States
(12) Patent Application Publication
(10) Pub. No.: US 2001/0012056 A1
(43) Pub. Date: Aug. 9, 2001

(54) IMAGE CAPTURING SYSTEM AND FILM HOLDING UNIT FOR USE IN THAT SYSTEM

(76) Inventors: MASAHIRO ARAI, SAITAMA-KEN (JP); TAKASHI NARASAWA, KANAGAWA-KEN (JP); TOSHIMI IIZUKA, KANAGAWA-KEN (JP); AKIRA FUKUSHIMA, KANAGAWA-KEN (JP); YOSHINARI ONDA, KANAGAWA-KEN (JP)

Correspondence Address: ROBIN BLECKER & DALEY, 2ND FLOOR, 330 MADISON AVENUE, NEW YORK, NY, 10017, US

(21) Appl. No.: 08/888,964

(22) Filed: Jul. 7, 1997

(30) Foreign Application Priority Data
Jul. 12, 1996 (JP) HEI-8-183822
Sep. 13, 1996 (JP) HEI-8-243156

(51) Int. Cl. H04N 5/253; H04N 9/47

(52) U.S. Cl. 348/96

(57) ABSTRACT

A plurality of film holding units capable of respectively holding a plurality of kinds of films having different formats are provided. The plurality of film holding units are each constructed to be attachable to and detachable from a joint portion provided on an attachment connected to a video camera. Such an arrangement allows for providing an image capturing system and film holding units for use in the system, capable of dealing with the plurality of kinds of films having different formats.

### BACKGROUND OF THE INVENTION

1. Field of the Invention

The present invention relates to an image capturing system for capturing, for example, an image obtained from a developed film and for processing or working the captured image, and also relates to a film holding unit for use in the image capturing system.

2. Description of Related Art

When images on snapshots or the like are picked up and recorded by a video camera and the recorded images are played back on a TV screen or the like, a unit such as a film holding device shown in FIG. 11 is conventionally used to cause the video camera to capture an image formed on a developed film. In such a film holding device, a developed 35 mm film 1 is pinched and thus held by a film holder 2. The film holder 2 is mounted to the film holding device 3 and is made so as to be slidable in the direction of the arrows. The film holding device 3 is attached to a filter thread portion at the tip of the lens of the video camera 4. This arrangement involves lighting being provided by an illumination device 5 for the process of capturing the image of the film 1 using the video camera 4.

Now, there has been a recent development in photography, wherein a developed film is kept to be stowed within a “patrone” (film cartridge). This system is called the “Advanced Photo System”. The film used for the Advanced Photo System is of a format different from that of 35 mm film, and is somewhat smaller than 35 mm film. Accordingly, the above-mentioned known film holding device 3 has not been able to be applied to such Advanced Photo System film.

### BRIEF SUMMARY OF THE INVENTION

The present invention has been made in light of the above-described problem, and accordingly, it is an object of the present invention to provide an image capturing system applicable to a plurality of kinds of film formats, and also to provide a film holding unit for use in the image capturing system.

To attain the above-described object, in accordance with an aspect of the present invention, there is provided an image capturing system for picking up a film image by using a video camera, which image capturing system comprises a first film holding unit for holding a film in such a manner as to enable the video camera to pick up an image formed on the film, a second film holding unit for holding a film of a format different from that of the film held by the first film holding unit, in such a manner as to enable the video camera to pick up an image formed on the film, and an attachment for replaceably attaching thereto and detaching therefrom either of the first film holding unit and the second film holding unit.

In accordance with another aspect of the present invention, there is provided a film scanner having an illumination unit for illuminating a film from behind and an image pickup unit for picking up an image formed on the film, and arranged to enable the image pickup unit to pick up an image formed on a film held by a first film holding unit or a film held by a second film holding unit and having a format different from that of the film held by the first film holding unit, the film scanner comprising an opening portion for inserting thereinto either of the first film holding unit and the second film holding unit, and a holding member for detachably holding either of the first film holding unit and the second film holding unit inserted from the opening portion.

In accordance with a further aspect of the present invention, there is provided an image projection apparatus having an illumination unit for illuminating a film from behind and a lens for projecting an image formed on the film illuminated by the illumination unit, and being capable of projecting an image formed on a film held by a first film holding unit or a film held by a second film holding unit and having a format different from that of the film held by the first film holding unit, the image projection apparatus comprising an opening portion for inserting thereinto either of the first film holding unit and the second film holding unit, and a holding member for detachably holding either of the first film holding unit and the second film holding unit inserted from the opening portion.

Further objects and features of the present invention will become apparent from the following detailed description of a preferred embodiment thereof taken in conjunction with the accompanying drawings.

### BRIEF DESCRIPTION OF THE SEVERAL VIEWS OF THE DRAWING

FIG. 1 is a perspective view illustrating an example of the configuration of an image capturing system according to an embodiment of the present invention;

FIG. 2 is a perspective view of a film viewer serving as a film holding unit in the embodiment of the present invention;

FIG. 3 is a perspective view illustrating an example of the principal construction of the image capturing system in the embodiment of the present invention;

FIGS. 4(A) and 4(B) are cross-sectional diagrams each illustrating an example of the construction of a joint portion in the embodiment of the present invention;

FIGS. 5(A) and 5(B) are cross-sectional diagrams each illustrating another example of the construction of the joint portion in the embodiment of the present invention;

FIGS. 6(A) and 6(B) are cross-sectional diagrams each illustrating a further example of the construction of the joint portion in the embodiment of the present invention;

FIG. 7 is a perspective view illustrating an example of the configuration of a system relating to application of a film scanner according to the present invention;

FIGS. 8(A) and 8(B) are cross-sectional diagrams each illustrating an example of the construction of a joint portion relating to application of the film scanner according to the present invention;

FIG. 9 is a perspective view illustrating an example of the configuration of a system relating to application of a projector according to the present invention;

FIG. 10 is a cross-sectional diagram illustrating an example of the construction of a joint portion relating to application of the projector according to the present invention; and

FIG. 11 is a perspective view illustrating an example of the configuration of a known image capturing system.

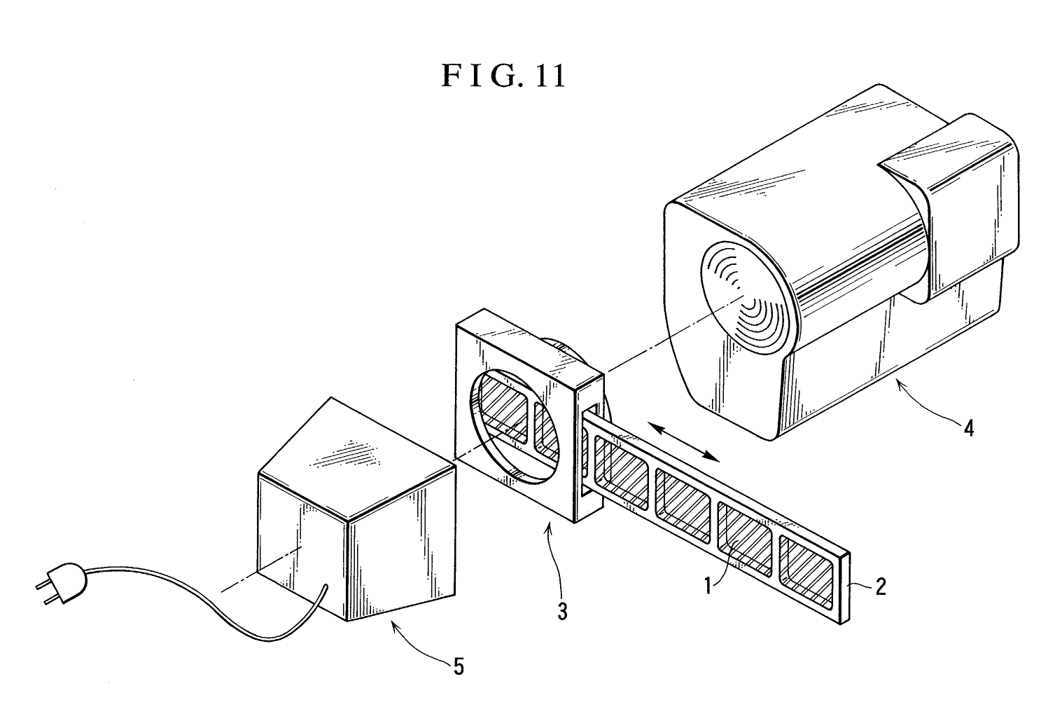

### DETAILED DESCRIPTION OF THE INVENTION

Hereinafter, a preferred embodiment of a film holding unit for use in an image capturing system or the like according to the present invention will be described in detail with reference to the drawings.

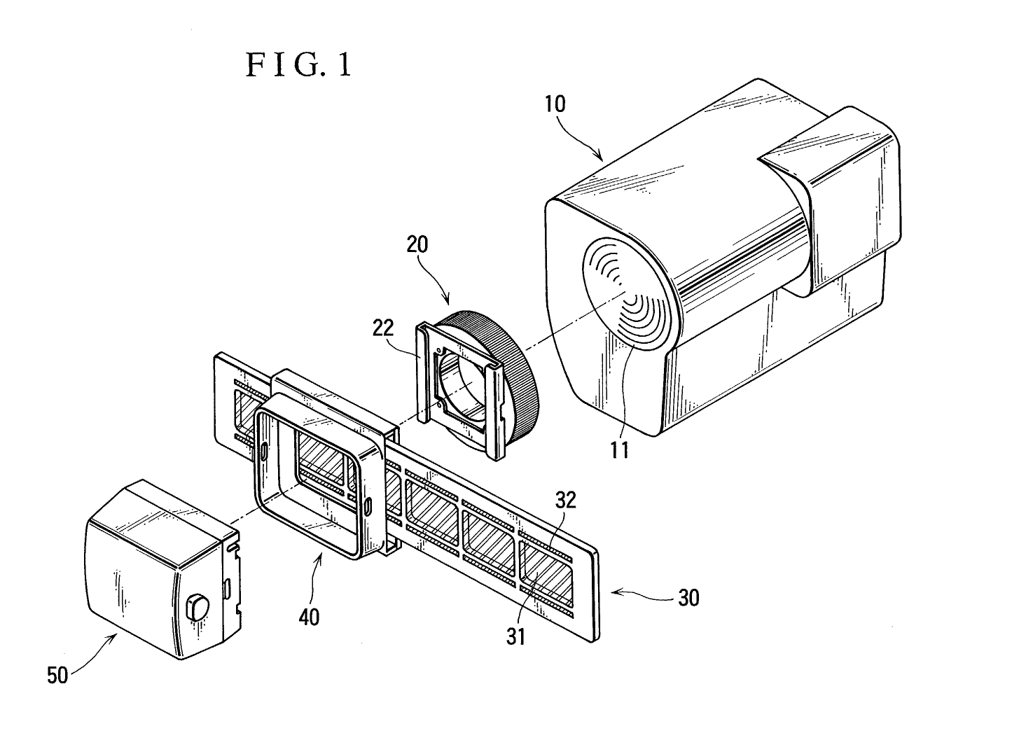

FIG. 1 illustrates an example of the configuration of the image capturing system according to the embodiment of the present invention. In the image capturing system, an image formed on a developed film (hereinafter, referred to as the film image) is picked up by a video camera to capture the film image and process and work the captured image. As shown in FIG. 1, the image capturing system is provided with a video camera 10, a connecting attachment 20 for attaching a 35 mm film adapter 40, a film holder 30 for holding the developed 35 mm film 31 and having a counter window 32 for making confirmation of the frame number and so on, the 35 mm film adapter 40 serving as a film holding unit to which the film holder 30 can be mounted, and an illumination device 50 which can be attached to the 35 mm film adapter 40.

The image capturing system is also configured so as to be able to capture the film image taken by the so-called “Advanced Photo System”. With the Advanced Photo System, the film (Advanced Photo System film) which has been developed is kept to be stowed in a film cartridge. The Advanced Photo System film is of a format which is different from that of the 35 mm film 31.

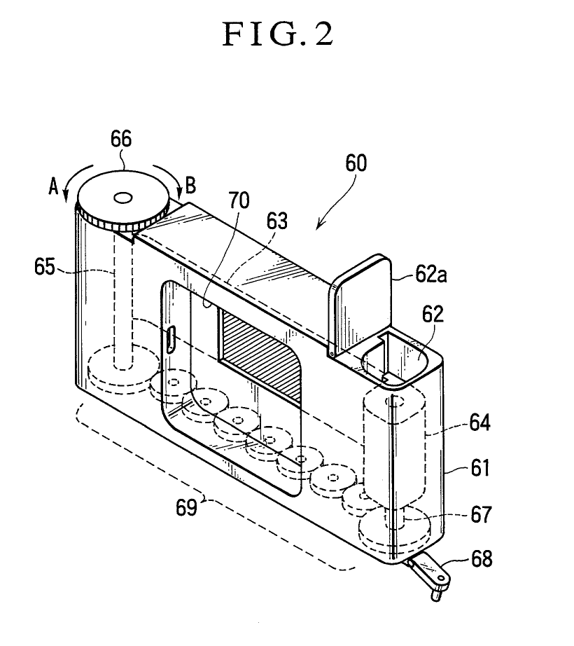

FIG. 2 illustrates a film viewer 60 serving as a film holding unit for capturing the film image obtained by the Advanced Photo System. The film viewer 60, which functions as a film holding unit similarly to the 35 mm film adapter 40 in the image capturing system according to the embodiment, is configured to be attached to the video camera 10 through the connecting attachment 20.

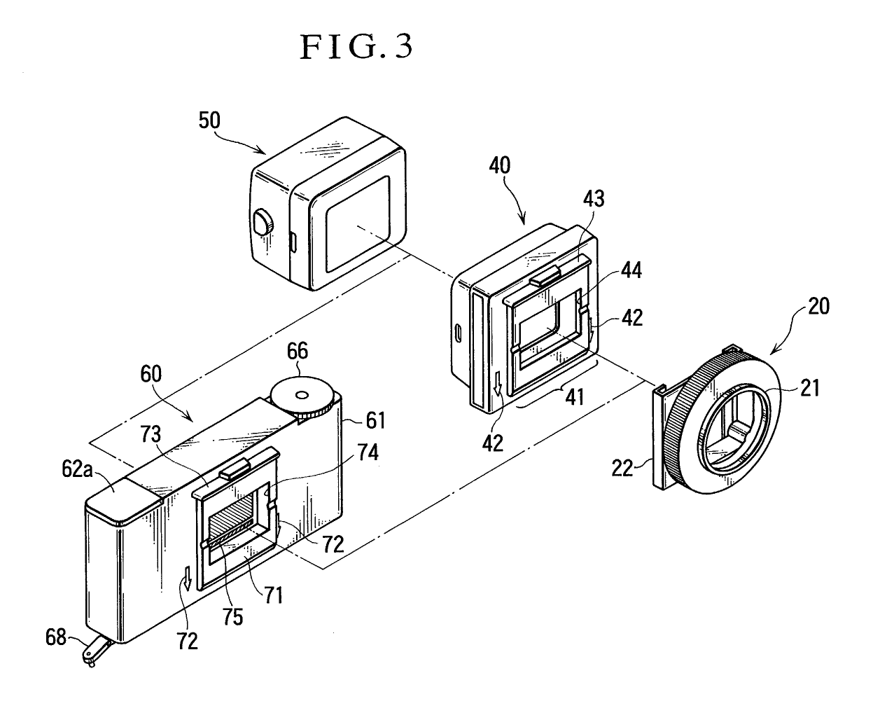

The connecting attachment 20 is configured to be screwed to the filter 11 on the tip of the lens of the video camera 10 by means of a threaded portion 21 of the connecting attachment (see FIG. 3). To the connecting attachment 20 is fixed a slide guide 22 formed as a frame, as shown in FIG. 1. The slide guide 22, which has an approximately U-shaped cross-section, is configured to allow a slider 41 of the 35 mm film adapter 40 to slidingly engage the slide guide 22. Arrow marks 42 are provided on either side of the slider 41, as shown in FIG. 3. The arrow marks 42 are for indicating the direction of insertion of the slider 41 when the slider 41 is made to engage the slide guide 22. Therefore, it is possible to cause the slider 41 to slidingly engage the slide guide 22 easily and accurately while following the arrow marks 42.

Also provided at the edge of the slider 41 is a stopper 43. When the slider 41 is caused to slidingly engage the slider guide 22, the slider guide 22 comes into contact with the stopper 43 to allow for positioning of the connecting attachment 20, i.e., of the 35 mm film adapter 40 relative to the video camera 10. The inner region of the slider 41 is formed to serve as a film observation window 44 for observing the film from the side of the video camera 10.

According to the system configuration shown in FIG. 1, the connecting attachment 20 is attached to the predetermined position on the video camera 10, and the 35 mm film 31 is attached to the film holder 30. Then, the 35 mm film adapter 40 is mounted to the connecting attachment 20 by means of a joint portion composed of the slide guide 22 and the slider 41 serving as joint members.

Here, in the film viewer 60 shown in FIG. 2, a body casing 61 is provided on its one end with a film loading portion 62 having a lid 62a, into which a film cartridge 64 stowing therein a developed Advanced Photo System film 63 is loaded. The developed Advanced Photo System film 63 is wound up by rotating a winding knob 66 of a film winding shaft 65 disposed on the other end of the body casing 61. By rotating the winding knob 66 in the direction of an arrow A or in the direction of an arrow B, the Advanced Photo System film 63 is respectively fed frame-by-frame or rewound accordingly. The Advanced Photo System film 63 which has been pulled out of the film cartridge 64 is rewound by rotating a rewinding shaft 67. In this case, rotating a rewinding crank 68 causes the rewinding shaft 67 to rotate, and also causes the film winding shaft 65 to rotate through a plurality of gears 69.

Also, an attaching window 70 is provided at the center portion of the body casing 61 for attachment of the illumination device 50. The Advanced Photo System film 63 is arranged to be exposed to the outside through the attaching window 70, and to be illuminated frame-by-frame by the illumination device 50 when passing before the attaching window 70.

Provided on the opposite side of the attaching window 70 in the body casing 61 is a slider 71, as shown in FIG. 3. The slider 71 is arranged to slidingly engage the slide guide 22 of the connecting attachment 20. Arrows 72 are provided on either side of the slider 71, indicating the direction of insertion of the slider 71 when the slider 71 is made to engage the slide guide 22. Also, provided at the end of the slider 71 is a stopper 73, with which the slide guide 22 comes into contact. The inner region of the slider 71 is formed as a film observation window 74 for observing the film from the side of the video camera 10, as in the case of the slider 41 of the 35 mm film adapter 40. A counter window 75 is provided in the observation window 74, for making confirmation of the frame number of the Advanced Photo System film 63 and so on.

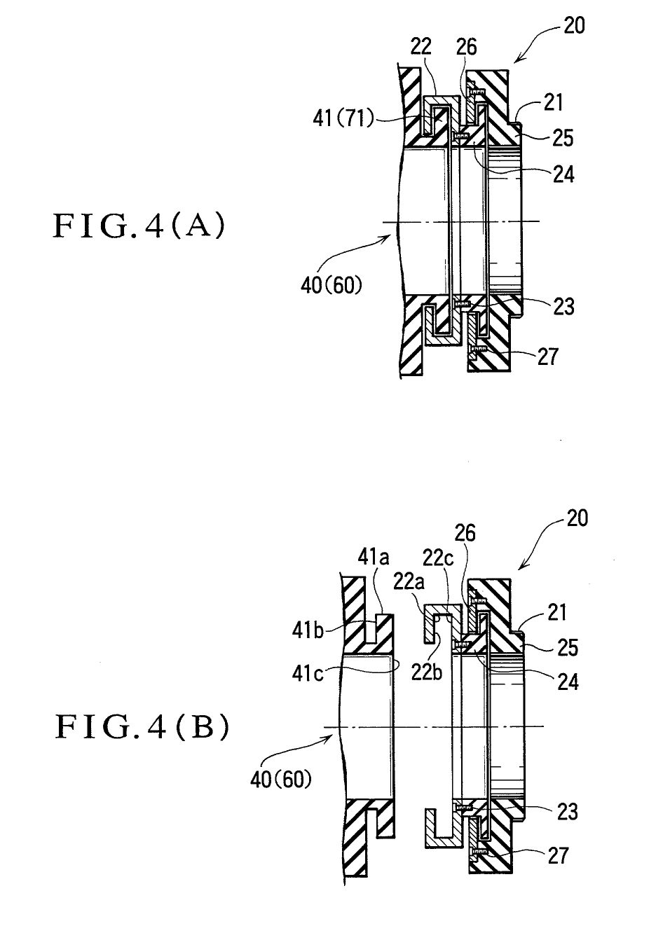

FIGS. 4(A) and 4(B) are cross-sectional diagrams, illustrating the joint portion between the slide guide 22 and the slider 41 (or the slider 71), as viewed from the direction of insertion of the slider 41 (or 71), in the embodiment. FIG. 4(A) shows the joint portion being in a connected state, and FIG. 4(B) shows the joint portion being in a separated state.

The connecting attachment 20 is composed of the slide guide 22 made preferably of metal plate which functions as a contact member with the 35 mm film adapter 40 or the film viewer 60, a rotating shaft 24 made preferably formed of resin to which the slide guide 22 is fixed by means of screws 23, an attachment body 25 preferably formed of resin which functions as a connecting member with the video camera 10, and a pressing plate 26 made of metal plate which holds the rotating shaft 24 incorporated into the attachment body 25. The pressing plate 26 is fixed to the attachment body 25 by means of screws 27. In this case, the rotating shaft 24 is incorporated into the attachment body 25 in such a manner that there is an appropriate gap between them, so that the rotating shaft 24 is freely rotatable relative to the attachment body 25.

By forming the constituent members of the connecting attachment 20 from resin or metal plate or the like, as described above, the combination thereof with the material for the slider 41 or slider 71 realizes excellent structure in terms of formability and strength, and further this is advantageous from a cost perspective owing to the ease of formation. Further, slidability preferable for the slider 41 or slider 71 to slide is obtained, so that a smooth operation can be ensured.

In the embodiment, the slider 41 (or slider 71) engages the slide guide 22 in the form of a slide shoe which is of the same construction as an accessory shoe. Here, the slider 41 (or slider 71) is formed of resin. The slider 41 has sliding surfaces 41a, 41b, and 41c, as shown in FIG. 4(B), and the slide guide 22 has sliding surfaces 22a, 22b, and 22c in correspondence to the sliding surfaces 41a, 41b, and 41c of the slider 41. These sliding surfaces come into sliding contact with each other with an appropriate gap formed therebetween, thus allowing for smooth sliding of the slider 41 (or slider 71) upon connecting of the 35 mm film adapter 40 or the film viewer 60 with the connecting attachment 20.

In the above construction, when an image formed on the 35 mm film 31, for example, is to be captured, the 35 mm film adapter 40 is used. The film holder 30 holding the 35 mm film 31 is mounted to the 35 mm film adapter 40, as shown in FIG. 1. Then, the 35 mm film adapter 40 is connected to the connecting attachment 20. In this instance, the slider 41 is slidingly engaged with the slide guide 22 following the arrow marks 42 as described above, so that the 35 mm film adapter 40 is attached to the video camera 10 through the connecting attachment 20.

In the 35 mm film adapter 40, sliding the film holder 30 appropriately causes the desired frame of the 35 mm film 31 to be positioned in the film observation window 44. At the same time, lighting the 35 mm film 31 from the rear side by the illumination device 50 attached to the 35 mm film adapter 40 allows an image of that frame to be captured at an appropriate level.

Also, when the 35 mm film adapter 40 is to be removed, sliding the slider 41 in the direction opposite to the arrows 42 allows for easy removal of the 35 mm film adapter 40 from the connecting attachment 20.

On the other hand, when the film image of the Advanced Photo System film 63 is to be captured by using the film viewer 60, sliding the slider 71 in the direction of the arrows 72 along the slide guide 22 so as to engage the slider 71 with the slide guide 22 allows the film viewer 60 to be attached to the video camera 10 through the connecting attachment 20. In the case of the film viewer 60 also, the desired frame of the Advanced Photo System film 63 can be located in the film observation window 74 by rotating the winding knob 66. At the same time, lighting the Advanced Photo System film 63 from the rear side by the illumination device 50 attached to the attaching window 70 of the body casing 61 allows an image of that frame to be captured at an appropriate level.

Thus, selecting the slider 41 or the slider 71 to slidingly engage the slide guide 22 of the single connecting attachment 20 allows for simple and sure engaging thereof. Accordingly, the 35 mm film adapter 40 or the film viewer 60 can be easily attached to the video camera 10 through the connecting attachment 20. Also, even in the case of exchanging between the 35 mm film adapter 40 and the film viewer 60, this operation can be performed smoothly.

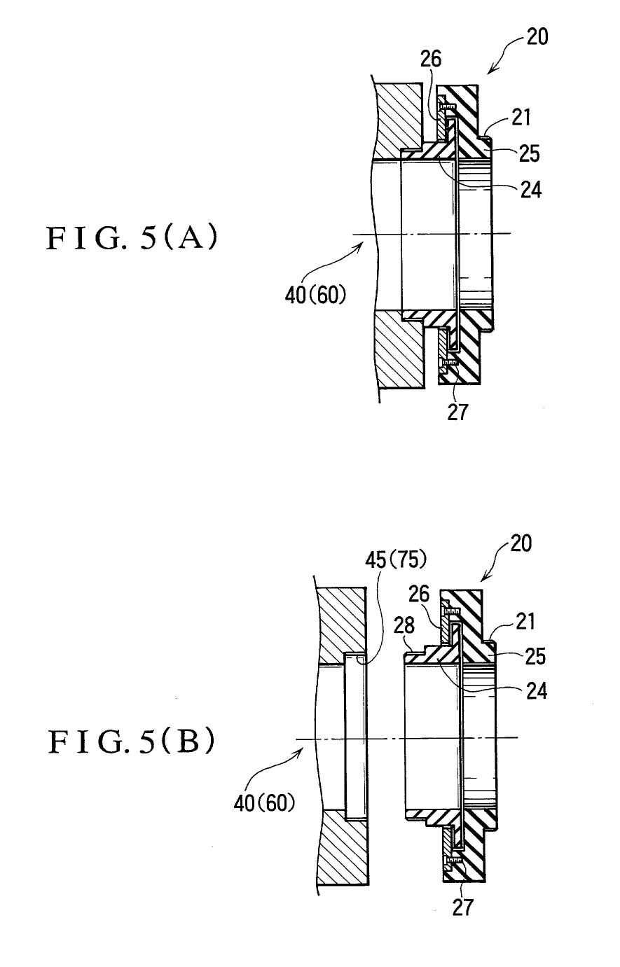

FIGS. 5(A) and 5(B) are cross-sectional diagrams each illustrating the construction of the joint portion between the connecting attachment 20 and the 35 mm film adapter 40 or the film viewer 60 according to the embodiment, in a constructional example different from that shown in FIGS. 4(A) and 4(B). FIG. 5(A) shows the joint portion between them being in a connected state, and FIG. 5(B) shows the joint portion between them being in a separated state.

According to the configuration shown in FIGS. 5(A) and 5(B), a protruding end portion of the rotating shaft 24 incorporated into the attachment body 25 on the side of the connecting attachment 20 is provided with a male screw 28. Also, the 35 mm film adapter 40 and the film viewer 60 are respectively provided with a female screw 45 and a female screw 75, which are able to screw to the male screw 28. The 35 mm film adapter 40 or the film viewer 60 can be attached to and detached from the connecting attachment 20 through these screw portions.

By screwing either the female screw 45 or the female screw 75 to the male screw 28 of the single connecting attachment 20, either of the 35 mm film adapter 40 and the film viewer 40 can be attached to the video camera 10 through the connecting attachment 20 in a simple and sure manner.

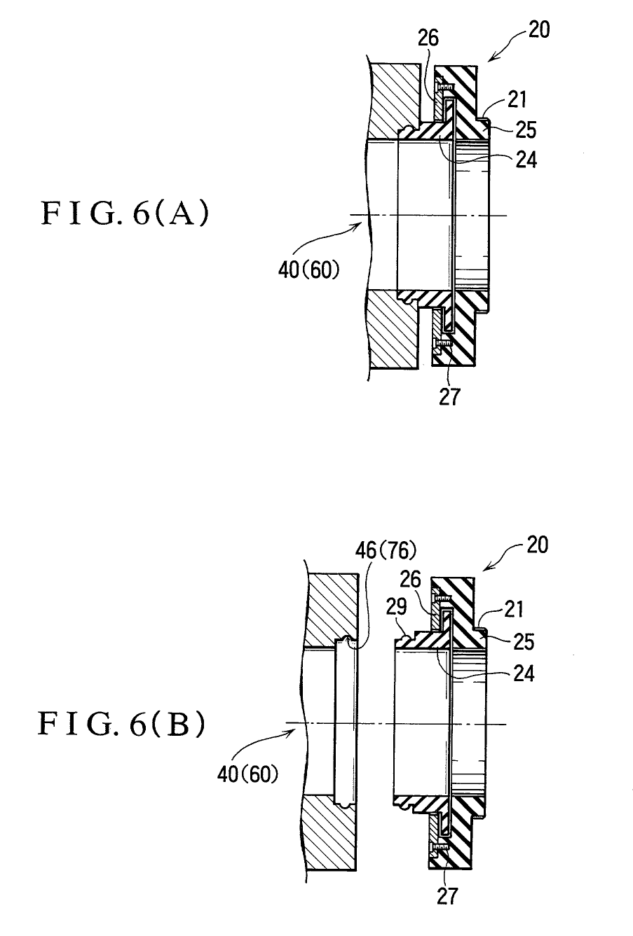

FIGS. 6(A) and 6(B) are cross-sectional diagrams each illustrating the construction of the joint portion between the connecting attachment 20 and the 35 mm film adapter 40 or the film viewer 60 according to the embodiment, in a constructional example different from those shown in FIGS. 4(A) and 4(B) and FIGS. 5(A) and 5(B). FIG. 6(A) shows the joint portion between them being in a connected state, and FIG. 6(B) shows the joint portion between them being in a separated state.

According to the configuration shown in FIGS. 6(A) and 6(B), a protruding end portion of the rotating shaft 24 incorporated into the attachment body 25 on the side of the connecting attachment 20 is provided with a protrusion 29. Also, the 35 mm film adapter 40 and the film viewer 60 are respectively provided with a recess 46 and a recess 76, which can fit on the protrusion 29. The 35 mm film adapter 40 or the film viewer 60 can be attached to and detached from the connecting attachment 20 through these recessed and protruding fitting portions in a simple and sure manner.

While in the above-described embodiment, an example has been described wherein a film viewer is applied to a video camera, but the present invention is by no means limited to such an arrangement, rather, the present invention may be applied similarly to other arrangements, such as that using a digital camera, for example.

Further, the embodiment of the present invention is further applicable to a film scanner. Next, the embodiment applied to the film scanner will be described.

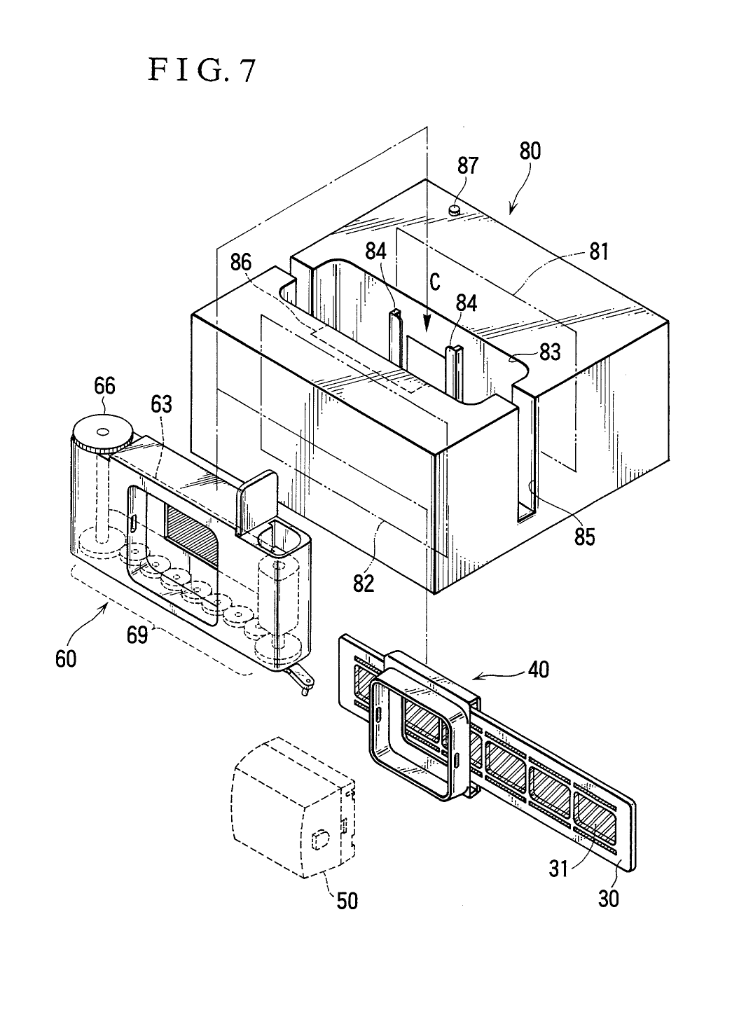

FIG. 7 illustrates an example of a system configuration related to a film scanner 80. In the embodiment, the film scanner 80 is configured such that a plurality of film holding units, i.e., the 35 mm film adapter 40 and the film viewer 60, can selectively be mounted thereto. The film scanner 80 is provided with an image pickup unit 81 for picking up an image formed on the 35 mm film 31 or the Advanced Photo System film 63 through the 35 mm film adapter 40 or the film viewer 60, and an illumination unit 82 which serves as a lighting source during the pickup operation.

The film scanner 80 has an opening portion 83 into which either of the 35 mm film adapter 40 and the film viewer 60 can be inserted (from the direction of an arrow C in FIG. 7). In the opening portion 83, there is provided a slide guide 84 for serving as a joint member constituting a joint portion between the film scanner 80 and the 35 mm film adapter 40 or the film viewer 60 serving as a film holding unit. In the embodiment, the slide guide 84 is provided on the side of the image pickup unit 81 in the opening portion 83, but it may be provided on the side of the illumination unit 82, instead.

Further, the 35 mm film adapter 40 and the film viewer 60 either of which is capable of attaching the illumination device 50 thereto can be realized by providing the slide guide 84 on the side of the image pickup unit 81, as in the embodiment. This construction is the same as in the later-described projector 90, as well.

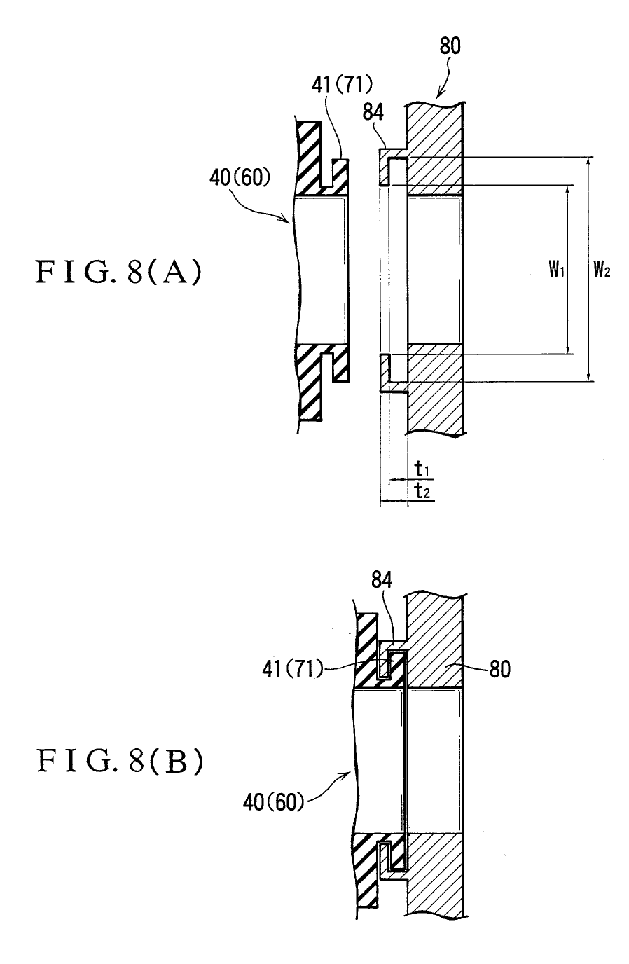

FIGS. 8(A) and 8(B) illustrate a specific construction of the slide guide 84 (as viewed from the direction of the arrow C in FIG. 7). The slide guide 84 can be formed integrally with (the casing of) the film scanner 80, and is formed into a key-shaped form or a U-shaped form, as shown in FIGS. 8(A) and 8(B). Regarding the dimensions w₁, w₂, t₁ and t₂ of the slide guide 84, these are substantially the same as those of the above-described slide guide 22 of the connecting attachment 20 (see FIGS. 4(A) and 4(B)). Accordingly, either of the slider 41 and the slider 71 of the 35 mm film adapter 40 and film viewer 60, respectively, is slidingly engaged with the slide guide 84 as a slide shoe. The slider 41 (or the slider 71) comes into sliding contact with the slide guide 84 with an appropriate gap existing therebetween. Accordingly, the slider 41 (or the slider 71) is allowed to slide in a smooth manner when the 35 mm film adapter 40 or the film viewer 60 is connected to the film scanner 80.

In the above construction, when an image formed on the 35 mm film 31, for example, is to be captured, the 35 mm film adapter 40 is used. The film holder 30 holding the 35 mm film 31 is mounted to the 35 mm film adapter 40, as shown in FIG. 7. Next, the 35 mm film adapter 40 is inserted into the opening portion 83 of the film scanner 80. Then, the slider 41 of the 35 mm film adapter 40 is slidingly engaged with the slide guide 84 along the arrows 42 (see FIG. 3), as shown in FIG. 8(B). Thus, the 35 mm film adapter 40 can be appropriately connected to the predetermined position of the film scanner 80.

Once the 35 mm film adapter 40 is mounted to the film scanner 80, the film holder 30 is passed through the slit 85 and slid appropriately so as to position the desired frame of the 35 mm film 31 in the film observation window 44. At the same time, illuminating the 35 mm film 31 from the back side by the illumination unit 82 allows an image of that frame to be captured by the image pickup unit 81 at an appropriate level.

The image pickup unit 81 has a line sensor composed of CCDs. This line sensor is arranged to be slidable in the same direction as the sliding direction of the film holder 30, the stroke distance thereof being equivalent to at least one frame of the 35 mm film 31. This arrangement allows the desired frame of the 35 mm film 31 to be scanned by the line sensor, by operating a sensor activating switch 87 of the film scanner 80.

In the above case, the 35 mm film 31 can be illuminated by the illumination device 50 attached to the 35 mm film adapter 40, instead of illumination by the illumination unit 82. In this case, as shown in FIG. 7, a recessed portion 86 is further provided in the opening portion 83 of the film scanner 80. When the 35 mm film adapter 40 to which the illumination device 50 has been attached is inserted into the opening portion 83, setting can be performed properly without the illumination device 50 interfering with the opening portion 83.

Also, when the 35 mm film adapter 40 is to be removed, sliding the slider 41 in the direction opposite to the arrows 42 easily removes the 35 mm film adapter 40 from the film scanner 80.

On the other hand, when the film image formed on the Advanced Photo System film 63 is to be captured by using the film viewer 60, the film viewer 60 is inserted into the opening portion 83 of the film scanner 80. The film viewer 60 can be attached to the film scanner 80 by slidingly engaging the slider 71 with the slide guide 84 along the arrows 72 (see FIG. 3). In the case of the film viewer 60 as well, the desired frame of the Advanced Photo System film 63 is located at the film observation window 74. At the same time, the Advanced Photo System film 63 is illuminated by the illumination unit 82 from the back side, and scanning of the desired frame is performed by the line sensor of the image pickup unit 81, thus allowing for capturing of the image appropriately. Illumination may be performed from the back side by the illumination device 50 attached to the attaching window 70 of the body casing 61 of the film viewer 60 instead of illumination by the illumination unit 82, in the case of the film viewer 60 as well.

In the above case, the winding knob 66 of the film viewer 60 is situated to protrude to such an extent that the finger of the operator can be engaged therewith, upon insertion of the film viewer 60 into the opening portion 83 of the film scanner 80. Such an arrangement for protruding the winding knob 66 enables the winding knob 66 to be easily rotated by the operator. Also, the Advanced Photo System film 63 within the film viewer 60 can be transported frame by frame by rotating the winding knob 66 by the manual operation.

Further, an electric frame transporting mechanism may be provided within the film scanner 80 for transporting the 35 mm film 31 or the Advanced Photo System film 63. For example, a driving gear connected to the output shaft of a driving motor of such an electric frame transporting mechanism is provided appropriately within the film scanner 80. On the other hand, a gear (rack) capable of meshing with the driving gear in the sliding direction of the film holder 30 (or in the case of the film viewer 60, so as to mesh with the gear 69 (see FIG. 7)) is provided. Inserting the 35 mm film adapter 40 or the film viewer 60 into the opening portion 83 causes linking thereof with the driving motor of the electric frame transporting mechanism by the transmission gear, thus allowing for frame transport of the 35 mm film 31 or the Advanced Photo System film 63 by a control device on the side of the film scanner 80.

Thus, either of the slider 41 and the slider 71 can be made to slidingly engage the single slide guide 84 in a simple and sure manner, and the 35 mm film adapter 40 or the film viewer 60 can be easily attached to the film scanner 80. In other words, a plurality of film holding units capable of holding respective kinds of films having different formats can be appropriately dealt with.

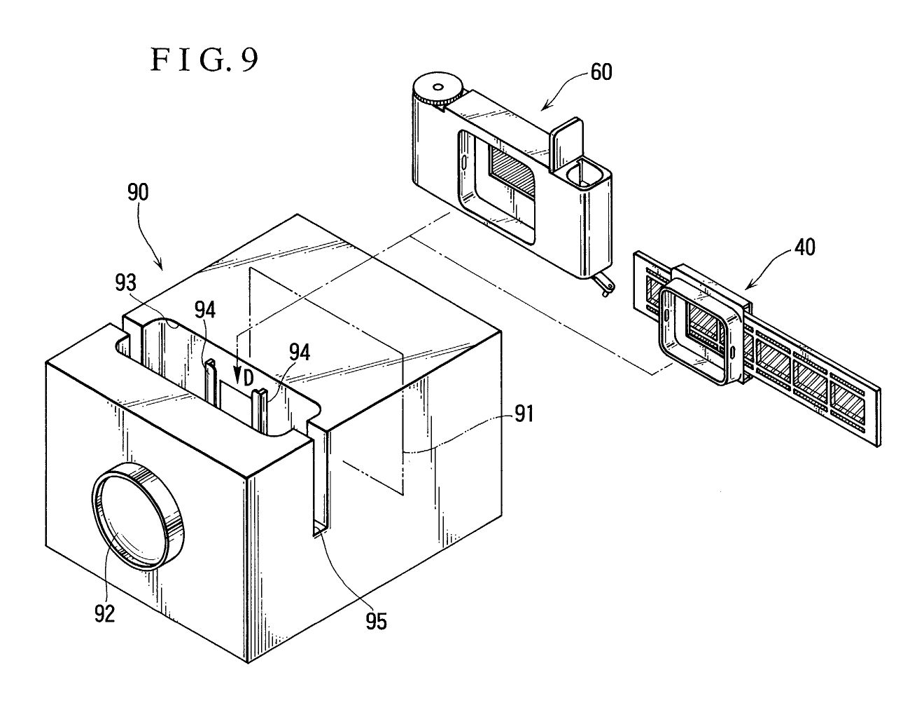

Further, FIG. 9 illustrates an example of a system configuration related to a projector 90 according to the embodiment of the present invention. The projector 90 is capable of mounting thereon either of the 35 mm film adapter 40 and the film viewer 60, and is provided with an illumination unit 91 for illuminating the 35 mm film 31 or the Advanced Photo System film 63 from the back side thereof through the 35 mm film adapter 40 or the film viewer 60, and a lens unit 92 for projecting the illuminated image.

The projector 90 is also provided with an opening portion 93 into which the 35 mm film adapter 40 or the film viewer 60 is inserted from the direction of an arrow D shown in FIG. 9. In the opening portion 93, there is provided a slide guide 94 serving as a joint member constituting a joint portion between the projector 90 and the 35 mm film adapter 40 or the film viewer 60. In the embodiment, the slide guide 94 is provided on the side of the illumination unit 91 in the opening portion 93, but it may be provided on the side of the lens unit 92, instead.

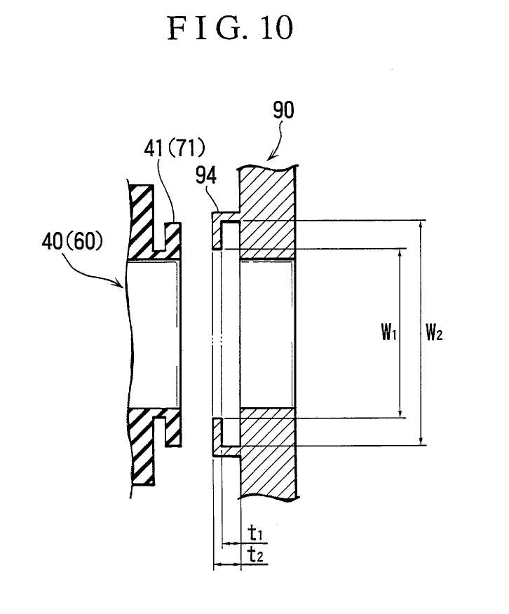

FIG. 10 illustrates a specific constructional example of the slide guide 94. The slide guide 94 may be formed integrally with the projector 90, and is formed so as to have a key-like shape as shown in FIG. 10. Regarding the dimensions w₁, w₂, t₁ and t₂, of the slide guide 94, these are substantially the same as those of the above-described slide guide 84 of the film scanner 80. Either of the slider 41 and slider 71 of the 35 mm film adapter 40 and the film viewer 60, respectively, comes into sliding contact with the slide guide 94 with an appropriate gap existing therebetween. Thus, the slider 41 (or the slider 71) of the 35 mm film adapter 40 (or the film viewer 60) is allowed to slide in a smooth manner and engage the slide guide 84.

In the above construction, when an image formed on the 35 mm film 31, for example, is to be projected, the 35 mm film adapter 40 is used. The film holder 30 holding the 35 mm film 31 is mounted to the 35 mm film adapter 40, as shown in FIG. 9. Next, the 35 mm film adapter 40 is inserted into the opening portion 93 of the projector 90. Then, the slider 41 of the 35 mm film adapter 40 is slidingly engaged with the slide guide 94. Thus, the 35 mm film adapter 40 can be appropriately connected to the predetermined position of the projector 90.

Once the 35 mm film adapter 40 is mounted to the projector 90, the film holder 30 is passed through the slit 95 and slid appropriately so as to locate the desired frame of the 35 mm film 31 in the film observation window 44. At the same time, illuminating the 35 mm film 31 from the back side by the illumination unit 91 allows the film image to be projected through the lens unit 92.

On the other hand, when the film image of the Advanced Photo System film 63 is projected by using the film viewer 60, the film viewer 60 is inserted into the opening portion 93 of the projector 90. The film viewer 60 can be attached to the projector 90 by slidingly engaging the slide guide 94. In the case of the film viewer 60 as well, the desired frame of the Advanced Photo System film 63 is located at the film observation window 74, and the Advanced Photo System film 63 is illuminated by the illumination unit 91 from the back side, thus allowing the film image to be projected through the lens unit 92.

In should be noted that frame transport of the 35 mm film 31 or the Advanced Photo System film 63 may be performed either by the manual operation or by the electric frame transporting mechanism, in the substantially same manner as in the example described in relation to the film scanner 80.

As described above, according to the embodiment of the present invention, the connecting construction or mechanism on the side of an image pickup apparatus such as a video camera or the like in an image capturing system can be made to correspond to a plurality of film holding units by means of a single connecting attachment or a single joint portion. In other words, a sharing arrangement has been provided for different film formats in an image processing apparatus, so that attaching or replacing of the film holding units can be performed in a simple and sure manner, thus realizing extremely excellent usability. Further, the present invention is advantageous in that working steps in developing and manufacturing of products can be reduced, and substantial lowering of costs can be achieved.

1. An image capturing system for picking up a film image by using a video camera, said image capturing system comprising:
a first film holding unit for holding a film in such a manner as to enable said video camera to pick up an image formed on the film;
a second film holding unit for holding a film of a format different from that of the film held by said first film holding unit, in such a manner as to enable said video camera to pick up an image formed on the film; and
an attachment for replaceably attaching thereto and detaching therefrom either of said first film holding unit and said second film holding unit.

2. An image capturing system according to claim 1, further comprising an illumination unit adapted to be held by said first film holding unit or said second film holding unit, for illuminating from behind a surface of the film to be picked up by said video camera.

3. An image capturing system according to claim 1, wherein said first film holding unit holds a film of 35 mm format.

4. An image capturing system according to claim 1, wherein said attachment is provided with a holding member for holding either of said first film holding unit and said second film holding unit.

5. An image capturing system according to claim 4, wherein each of said first film holding unit and said second film holding unit is provided with an engaging member which is held by said attachment by engaging said holding member.

6. An image capturing system according to claim 5, wherein said engaging member engages said holding member while sliding in parallel to a surface of the film which is held by said first film holding unit or said second film holding unit in such a manner as to enable said video camera to pick up an image formed on the film.

7. An image capturing system according to claim 6, wherein each of said first film holding unit and said second film holding unit is provided with an indicator for indicating a direction of sliding for causing said engaging member to engage said holding member.

8. An image capturing system according to claim 4, wherein said attachment is further provided with a rotating shaft for allowing said holding member to rotate relative to said attachment.

9. An image capturing system according to claim 1, wherein said second film holding unit comprises:
a stowage portion for stowing a film cartridge therein;
a film winding mechanism for winding a film out of the film cartridge stowed in said stowage portion, to allow said video camera to pick up an image formed on the film; and
a film observation window through which a surface of the film wound by said film winding mechanism can be observed.

10. An image capturing system according to claim 9, wherein said second film holding unit further comprises an illumination unit for illuminating the film surface from said film observation window.

11. A film scanner having an illumination unit for illuminating a film from behind and an image pickup unit for picking up an image formed on the film, and arranged to enable said image pickup unit to pick up an image formed on a film held by a first film holding unit or a film held by a second film holding unit and having a format different from that of the film held by said first film holding unit, said film scanner comprising:
an opening portion for inserting thereinto either of said first film holding unit and said second film holding unit; and
a holding member for detachably holding either of said first film holding unit and said second film holding unit inserted from said opening portion.

12. A film scanner according to claim 11, wherein said first film holding unit holds a film of 35 mm format.

13. A film scanner according to claim 11, further comprising a second illumination unit adapted to be held by said first film holding unit or said second film holding unit, for illuminating from behind a surface of the film to be picked up by said image pickup unit.

14. A film scanner according to claim 13, wherein said opening portion is provided with a recessed portion for allowing said second illumination unit to be inserted into said opening portion.

15. An image projection apparatus having an illumination unit for illuminating a film from behind and a lens for projecting an image formed on the film illuminated by said illumination unit, and being capable of projecting an image formed on a film held by a first film holding unit or a film held by a second film holding unit and having a format different from that of the film held by said first film holding unit, said image projection apparatus comprising:
an opening portion for inserting thereinto either of said first film holding unit and said second film holding unit; and
a holding member for detachably holding either of said first film holding unit and said second film holding unit inserted from said opening portion.

16. An image projection apparatus according to claim 15, wherein said first film holding unit holds a film of 35 mm format.

17. A film viewer capable of holding a film cartridge in which a film is stowed, said film viewer comprising:
a stowage portion for stowing the film cartridge therein;
a film winding mechanism for winding the film out of the film cartridge stowed in said stowage portion; and
a film observation window through which a surface of the film wound by said film winding mechanism can be observed.

18. An attachment adapted for picking up a film image by using a video camera, said attachment comprising:
a holding member for replaceably attaching thereto and detaching therefrom either of a first film holding unit for holding a film of a first format in such a manner as to enable said video camera to pick up an image formed on the film and a second film holding unit for holding a film of a second format different from the first format in such a manner as to enable said video camera to pick up an image formed on the film.
